(19) United States
(12) Patent Application Publication
(10) Pub. No.: US 2011/0021245 A1
(43) Pub. Date: Jan. 27, 2011

(54) MOBILE-PHONE TERMINAL, AND HIGH-FREQUENCY MULTIPLEXING AND SWITCHING SYSTEM

(75) Inventor: Hirotada TANIUCHI, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SONY ERICSSON MOBILE COMMUNICATIONS AB, Lund (SE)

(21) Appl. No.: 12/823,741

(22) Filed: Jun. 25, 2010

(30) Foreign Application Priority Data
Jul. 27, 2009 (JP) 2009-174418

(51) Int. Cl. H04M 1/00; H04B 1/38

(52) U.S. Cl. 455/552.1; 455/560; 455/572

(57) ABSTRACT

A mobile-phone terminal is provided by including a switching unit for selectively connecting, compliant with several communication systems, a plurality of signal paths of high frequency transmission and reception signals to an antenna, and a high frequency control unit for controlling the switching unit. The switching unit includes switching devices configured to perform ON/OFF operations of respective signal paths, and a logic circuit for generating switching control signals for the switching devices and ON/OFF control signals for controlling power amplifiers. The power amplifiers are controlled not directly by the high frequency control unit, but by way of the switching unit for switching the signal paths of high frequency transmission and reception signals.

### BACKGROUND OF THE INVENTION

1. Field of the Invention

The invention relates to mobile-phone terminals, and high-frequency multiplexing and switching systems. More particularly, the invention relates to a high-frequency switching system and a mobile-phone terminal incorporating the switching system.

2. Description of the Related Art

Mobile-phone terminals of the third generation (3G) are each provided in general with transmission and reception capabilities compliant with communication systems and frequency band specifications for respective regions. When manufactured with the specifications for one region with two or more communication systems and frequency bands, or alternatively with other specifications for covering several regions, high frequency (RF radio frequency) circuits are designed to fulfill respective transmission and reception capabilities of these communication systems and frequency bands.

For example, multi-band enabled mobile-phone terminals have been devised compliant with the systems such as UMTS (Universal mobile telecommunications system), GSM (Global system for mobile communications service), and so forth.

Mobile-phone terminals are each provided with power amplifiers (PA), high frequency switching units, and high frequency control units.

The high frequency control unit includes a transmission circuit for processing transmission signals and a reception circuit for processing reception signals respectively in each of the four bands, and further includes a control unit for performing the control of the transmission and reception circuits. The transmission signals in each band are inputted to corresponding power amplifiers. Since the current consumption is relatively large for each power amplifier, it is desirable not to operate in the operation mode of standby, awaiting reception, or only reception. Therefore, the power amplifiers are each configured to be subjected to ON/OFF control by control signals outputted from the high frequency control unit as to selectively be activated.

There is disclosed in Japanese Unexamined Patent Application Publication No. 2005-123740, a high frequency switching module for switching among three communication systems such as GSM system, DCS (Digital communications system), and PCS (Personal communications service).

In Japanese Unexamined Patent Application Publication No. 2008-271420, a further switching module is disclosed by including FET switching circuits and filter circuits, which is configured to switch transmission paths corresponding to two or more communications systems, through which transmission signals of the communications system passes.

In Japanese Unexamined Patent Application Publication No. 2008-124805, an antenna switch is disclosed for switching an antenna of communication equipment to either transmission circuit or receiving circuit, specifically related to a semiconductor switching integrated circuit which includes a decoder circuit for supplying output voltages from DC-DC conversion circuit to a switching circuit in response to path switching signals applied from the exterior.

### SUMMARY OF THE INVENTION

As the number of corresponding bands increases for the multi-band mobile-phone terminals abovementioned, the number of control signals outputted from the high frequency control unit has to increase, that is necessary for suitably controlling the amplifier units and switching units. In addition, in the high frequency control unit, the block for processing high frequency signals, and further block for controlling amplifier units and switching units, are generally arranged to be separated with each other in order to reduce the interference between the blocks and the detouring of noises. Therefore, it is difficult in the high frequency control unit to arrange so that the terminal connected to the switching unit and to the amplifying unit is placed close to the terminal connected to high frequency signals.

In such a situation, the paths of control signals from the high frequency control unit, in general, tend to intersect the paths of high frequency transmission and reception signals. However, since high frequency transmission and reception signals are necessary to be prevented from the influence of external noises, and the paths of the high frequency transmission and reception signals are formed with strip lines or micro strip lines for achieving low transmission loss, the layout of the signal paths is subjected to constraints regarding the high frequency transmission and reception signal paths and the intersecting control signal paths. Consequently, there may result in the redundancy and complexity in the layout.

The present invention is achieved in view of the background mentioned above to make it feasible to simplify the layout of high frequency transmission and reception signal paths and control signal paths in mobile-phone terminals compliant with two or more communication systems.

A mobile-phone terminal according to an embodiment of the invention is provided by including an antenna; a switching unit configured to switch for selectively connecting a first plurality of signal paths of high frequency transmission and reception signals to the antenna, the first plurality of signal paths being in compliant with a second plurality of communication systems; a high frequency control unit configured to perform a switching control of the switching unit; and a third plurality of power amplifiers configured to perform a power amplification of the high frequency transmission and reception signals compliant with the second plurality of communication systems. In this configuration, the switching unit includes a fourth plurality of switching means for performing ON/OFF operations of each of the signal paths, and a logic circuit configured, in response to control signals outputted from the high frequency control unit, to generate switching control signals for switching the fourth plurality of switching means and ON/OFF control signals for controlling the third plurality of power amplifiers.

Therefore, the power amplifiers are therefore controlled not directly by the high frequency control unit, but by way of the switching unit which is configured to switch the signal paths of high frequency transmission and reception signals from the high frequency control unit.

A part of the switching control signals for switching the fourth plurality of switching means is shared as ON/OFF control signals for controlling at least one of the power amplifiers.

The logic circuit may be configured, in response to control signals outputted from the high frequency control unit, to generate independent power amplifier control signals for controlling the third plurality of power amplifiers. In this case, the switching unit further includes logic gates for generating ON/OFF control signals for controlling at least one of the power amplifiers, and the logic gates are configured to generate logical product outputs as ON/OFF control signals for controlling the power amplifiers, in which the logical product outputs are derived from the switching control signals for switching the switching means and the power amplifier control signals outputted from the logic circuit. With this configuration, the instability of the state of switching means, which is caused by switching the power amplifiers, can be prevented.

In addition, the switching unit further includes logic gates for generating ON/OFF control signals for controlling at least one of the power amplifiers, and the logic gates may be configured to generate logical product outputs as ON/OFF control signals for controlling the power amplifiers, in which the logical product outputs are derived from the switching control signals for switching the switching means and the power amplifier control signals outputted from the high frequency control unit. With this configuration, by supplying the power amplifier control signals outputted from the high frequency control unit directly to the logic gates, the influence can be excluded, the influence being caused by the variation in delay of the control signal from the logic circuit included in the switching unit.

The switching unit further includes voltage conversion means for raising a control voltage of at least one of the switching means, and the logic circuit may be configured to increase the control voltage of the switching means with the voltage conversion means only during the period of transmission of at least one of the communication systems. With this configuration, the control voltages of the switching means are increased, the stable operations of the switching means are secured during transmission, while wasteful current consumption of the switching unit can be alleviated during the period when no transmission occurs.

A high-frequency multiplexing system according to an embodiment of the invention is provided by including a switching unit configured to switch for selectively connecting signal paths of high frequency transmission and reception signals compliant with a second plurality of communication systems, and a high frequency control unit configured to perform a switching control of the switching unit. In this configuration, the switching unit includes a fourth plurality of switching means for performing ON/OFF operations of each of the signal paths, and a logic circuit configured, in response to control signals outputted from the high frequency control unit, to generate switching control signals for switching the fourth plurality of switching means and ON/OFF control signals for controlling the third plurality of power amplifiers for performing a power amplification of high-frequency transmission signals.

A high-frequency switching system according to an embodiment of the invention is a switching unit configured to switch for selectively connecting a first plurality of signal paths of high frequency transmission and reception signals, the first plurality of signal paths being compliant with a second plurality of communication systems, which is provided by including a fourth plurality of switching means for performing ON/OFF operations of each of the signal paths, a sixth plurality of control input terminals for receiving a seventh plurality of control signals from the exterior, a logic circuit configured, in response to the seventh plurality of control signals, to generate switching control signals for switching the fourth plurality of switching means and ON/OFF control signals for controlling the third plurality of power amplifiers for performing a power amplification of high-frequency transmission signals, and an eighth plurality output terminals for outputting the ON/OFF control signals for controlling the third plurality of power amplifiers.

According to embodiments of the present invention, by performing ON/OFF controls of the power amplifiers with the high frequency control unit by way of the switching unit, it becomes feasible to simplify the layout of high frequency transmission and reception signal paths and control signal paths.

### BRIEF DESCRIPTION OF THE DRAWINGS

FIG. 1 illustrates the general configuration of the portion of multi-band mobile-phone terminal related to the invention;

FIG. 2A illustrates the configuration of the portion of multi-band mobile-phone terminal related to the present invention according to an embodiment;

FIG. 2B illustrates the states of the switch and the power amplifier at several operation steps with the band 1;

FIG. 3 is a diagram illustrating ON/OFF states of each switch and power amplifier corresponding to various operation process with the configuration of FIG. 2;

FIG. 4 includes a truth table illustrating the input-and-output relation of logic circuit in the switching unit of FIG. 2;

FIG. 5 illustrates the configuration of the portion of multi-band mobile-phone terminal related to the present invention according to a second embodiment;

FIG. 6 is a diagram illustrating ON/OFF states of each of the switches and power amplifiers, and of the control signal corresponding to various operation process with the configuration of FIG. 5;

FIG. 7 includes a truth table for the logic circuit included in the switching unit of FIG. 5;

FIGS. 8A and 8B illustrate the changes of control signal in response to the change of control signal for the first and second embodiments, respectively;

FIG. 9 illustrates the configuration of the portion of multi-band mobile-phone terminal related to the present invention according to a third embodiment;

FIG. 10 illustrates the configuration of the portion of multi-band mobile-phone terminal related to the present invention according to a fourth embodiment;

FIG. 11 is a diagram illustrating ON/OFF states of respective switches, the second switching unit, respective power amplifiers, and of the control signal corresponding to various operation process with the configuration of FIG. 10;

FIG. 12 includes a truth table for the logic circuit in the switching unit of FIG. 10;

FIG. 13A illustrates the configuration of the portion of multi-band mobile-phone terminal related to the present invention according to a fifth embodiment; and

FIG. 13B shows a diagram illustrating the states related to the configuration of FIG. 13A.

### DESCRIPTION OF THE PREFERRED EMBODIMENTS

Referring now to the drawings, preferable embodiments of the present invention will be detailed hereinbelow.

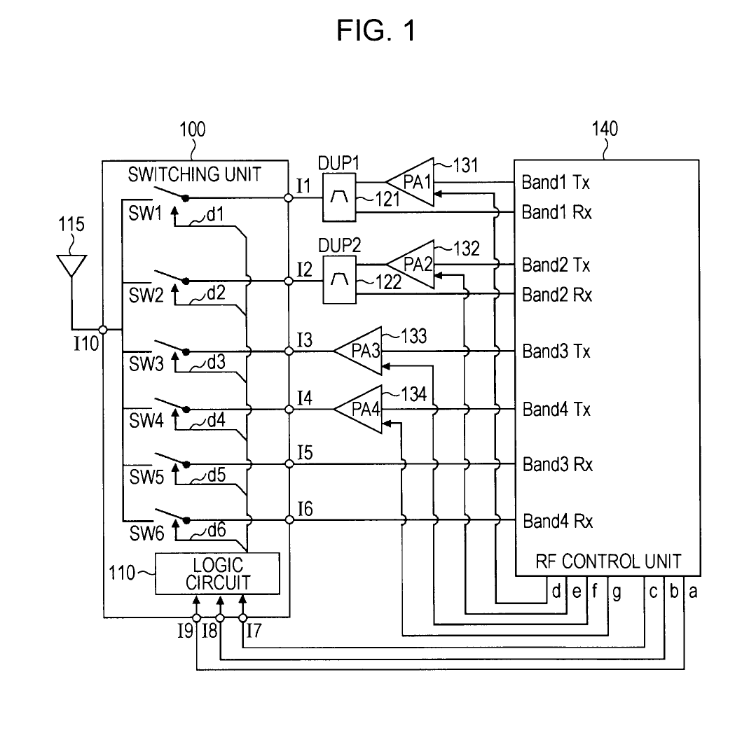

FIG. 1 illustrates the general configuration of the portion of multi-band mobile-phone terminal related to the invention.

Referring to FIG. 1, the structure of a high frequency multiplexing system is shown, conforming to multiple bands including two bands (Band1 and Band2) of UMTS, and further two bands (Band3 and Band4) of GSM. In this case, there included are two bands in each of the communication systems, one capable of performing both transmission and reception simultaneously such as UMTS, CDMA (Code division multiple access), and so forth, and the other not capable of performing both transmission and reception simultaneously such as GSM, GPRS (General packet radio service), and so forth. The high frequency multiplexing system is provided by including a switching unit 100 configured to switch among signal paths of high frequency transmission and reception signals for a first plurality of the communication systems, and a high frequency (RF) control unit 140 configured to perform switching controls of the switching unit 100.

Although the interior thereof is not illustrated in detail, the high frequency control unit 140 includes a transmission circuit for processing transmission signals and a reception circuit for processing reception signals, each for the four bands, and additionally includes a control unit for controlling these circuits. The control unit is provided by including processors and ASICs, which are not shown.

The high frequency control unit 140 includes a processing unit for performing several processing such as coding processing, modulation processing, and so forth for the bands 1 through 4, and is configured to output high frequency transmission signals of the selected band. The high frequency transmission signals of each band are inputted into each of corresponding power amplifiers (PA1 to PA4) 131 to 134.

In addition, the high frequency control unit 140 is configured to receive high frequency reception signals of each of the bands 1 to 4, and perform necessary processing such as demodulation processing, decode processing, and so forth corresponding to each band with respective reception circuits.

The switching unit (high frequency switching unit) 100 includes a second plurality of switches SW1 to SW6 each for performing connection/disconnection of the high frequency transmission and reception signal paths of each band, and is configured, on receiving control signals from the high frequency control unit, to generate control signals for controlling each of the switches, and control the switches so that the transmission and reception signal paths are arbitrarily connected to an antenna. Namely, by means of these switches, the connection/disconnection steps of the antenna 115 and each of the high frequency transmission and reception signal paths are carried out. The switches (SW) in the present embodiment are provided with switch means each formed with semiconductor switches such as FETs and so forth, or mechanical switches such as MEMS and so forth. Regarding the transmission and reception signal paths, there are cited the cases, depending on the communication system, one being the high frequency transmission path and the high frequency reception path are formed in common, and the other being separated. For the communication system for carrying out the transmission and reception simultaneously such as UMTS, the high frequency transmission path and the high frequency reception path are connected to one single switch by way of a duplexer. In the present illustration, the bands 1 and 2 each utilize one common path for the transmission and reception. The logic circuit 110 included in the switching unit 100 is configured, on receiving control signals a, b, and c from the high frequency control unit 140, to generate control signals d1 to d6 for controlling each of switches SW1 to SW6. With the present configuration, necessary and arbitrary combination of ON/OFF of the switches SW1 to SW6 and of power amplifiers PA1 to PA4 becomes feasible in response to the control of the high frequency control unit 140. In addition, the switching unit 100 may be formed with an integrated circuit (IC), and includes input and output terminals I1 to I10.

Each of the power amplifiers (PA) 131 to 134 has the capability of amplifying transmission signals of each band to a predetermined output power. Since the current consumption is relatively large for each power amplifier (PA), it is desirable not to operate in the operation modes of standby, awaiting reception, and only reception. Therefore, the power amplifiers 131 to 134 are each configured to be subjected to ON/OFF control by control signals d, e, f, and g outputted from the high frequency control unit 140 as to be actuated selectively.

In order to carry out the transmission and reception simultaneously with one antenna 115, each of the duplexers (DUP) 121 and 122 has the capability of distributing transmission and reception signals of the respective band to a predetermined high frequency transmission and reception signal path by taking advantage of differences of the frequency between transmission and reception signals included in each of the band 1 and band 2. Namely, in the communication system such as UMTS and so forth in which the transmission and reception are carried out simultaneously, the duplexer performs the switching of the path of transmission and reception, while the switching unit 100 performs only the switching the bands.

In contrast, in the (time division) communication system such as GSM, in which the transmission and reception are divided by time, the switching unit 100 performs both the transmission and reception, and the switching the signal paths of the high frequency transmission and reception signals.

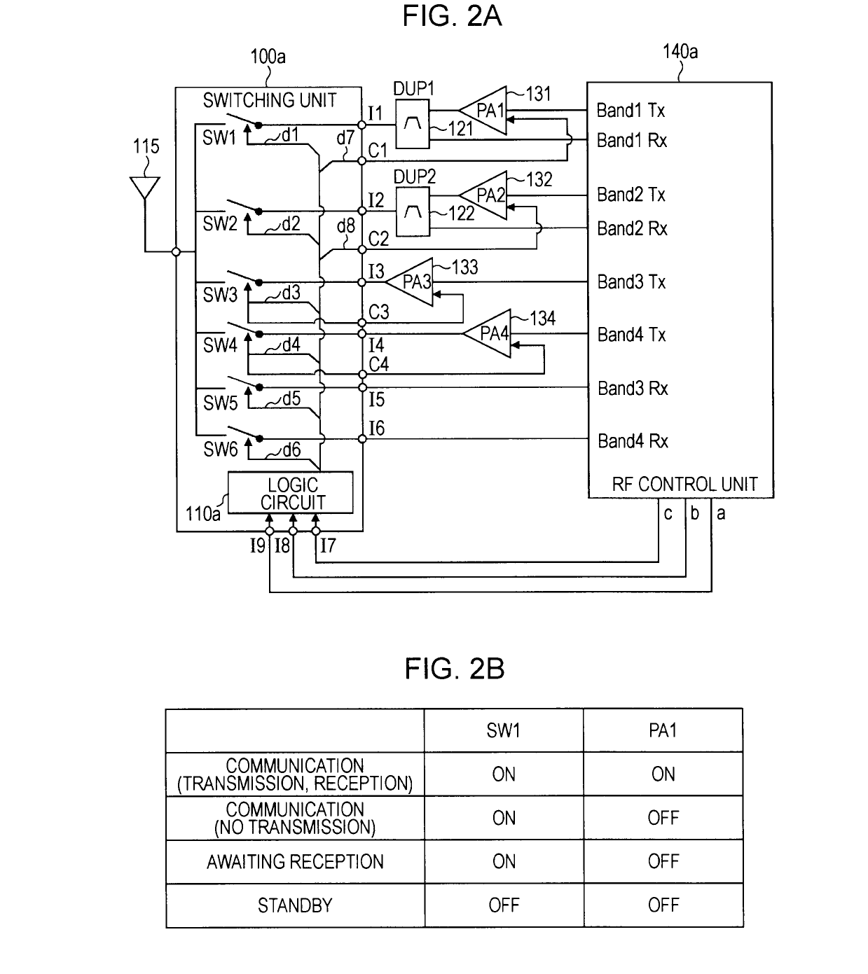

FIG. 2A illustrates the configuration of the portion of multi-band mobile-phone terminal related to the present invention according to an embodiment. The components included in the drawing similar to those shown in FIG. 1 are indicated with identical numerical representations and the repeated description thereof is herewith excluded. FIG. 2B illustrates the states of the switch SW1 and the power amplifier PA1 at several operation steps with the band 1.

The point differing from the configuration of FIG. 1 is that the previous seven control signal lines, a through g, outputted from the high frequency control unit 140 are reduced to three control signal lines, a through c, and that the structure of the switching unit 100 is modified into the switching unit 100a according to the control signal line reduction. The logic circuit 110a is configured, on receiving control signals, a through c, from the high frequency control unit 140a to the control input terminals, I7 through I9, to generate ON/OFF control signals for controlling power amplifiers, 131 through 134, together with switching control signals for SW1 through SW6. These ON/OFF control signals are outputted to power amplifiers 131 through 134 by way of the control output terminals c1 through c4.

As shown in FIG. 2B, for the case of band 1 of UMTS, for example, both SW1 and PA1 are turned on during the communication (transmission and reception), while SW1 is turned on and PA1 is off during the communication (no transmission occurs). In addition, SW1 is turned on and PA1 is off during awaiting reception, and both SW1 and PA1 are turned off during standby.

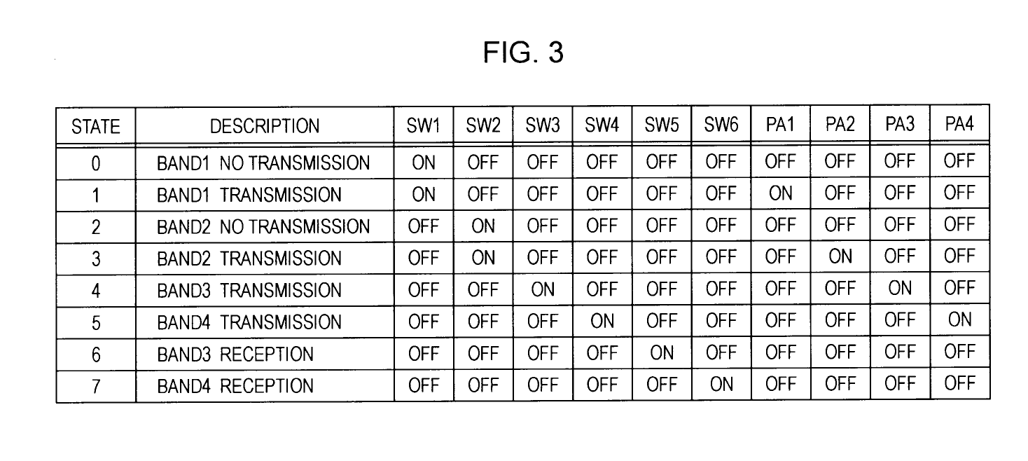

FIG. 3 is a diagram illustrating ON/OFF states of each switch (SW) and power amplifier (PA) corresponding to several operation process with the configuration of FIG. 2. The relation between each band and the states is as follows.
For Band1, in the state 0 during no transmission occurs, while in the state 1 during transmission occurs;
for Band2, in the state 2 during no transmission occurs, while in the state 3 during transmission occurs;
for Band3, in the state 6 during reception occurs, while in the state 4 during transmission occurs;
   and
for Band4, in the state 7 during reception occurs, while in the state 5 during transmission occurs.
   It may be added that “standby” shown in FIG. 2A is the operation primarily concerned with PA1, and that further examples are shown in FIG. 3 in which other bands correspond to active states.

As found in FIG. 3, the ON/OFF pattern of PA3 is the same as the ON/OFF pattern of SW3. In addition, the ON/OFF pattern of PA4 is the same as that of SW4. For the communication system not simultaneously performing both transmission and reception, the transmission and reception are carried out by the switching unit. In addition, the amplifier unit is activated only during the period of transmission. Thus, the operation of the switch connected to the amplifier unit coincides with that of the amplifier unit. As a result, switching control signals d3 and d4 of SW3 and SW4 can be utilized as ON/OFF control signal of PA3 and PA4, respectively. In the present invention, therefore, it is devised that the power amplifier system is controlled by increasing the number of outputs of logic circuit 110a in the switching unit 100 and by outputting a part thereof to the outside of the switching unit.

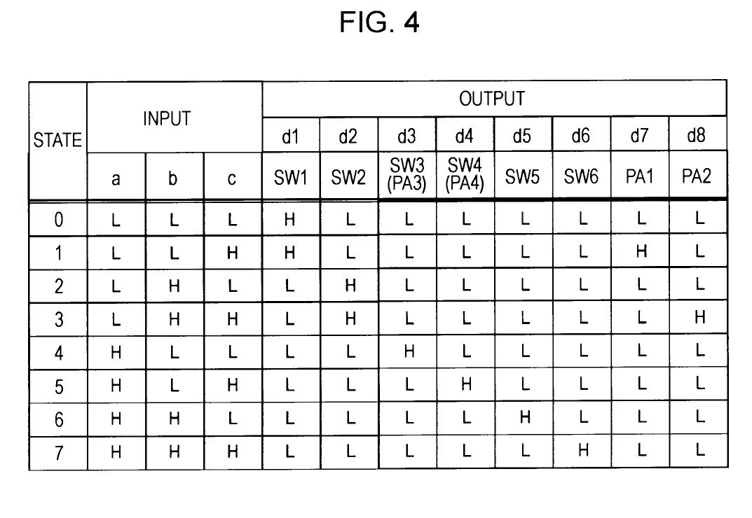

FIG. 4 includes a truth table illustrating the input-and-output relation of logic circuit 110a included in the switching unit 100a of FIG. 2. The logic circuit 110a used herein is the logic circuit of 3 input-8 output. Control signals d1 to d6, out of the signals d1 to d8 outputted from the logic circuit 110a, are used for controlling SW1 to SW6, respectively. In addition, the control signal d3 is shared for controlling PA3 and SW3, and the control signal d4 is shared for controlling PA4 and SW4. The control signal d7 is used for controlling PA1, and the control signal d8 is used for controlling PA2. For forming the logic circuit 110a, several devices may be used such as the combination of logic circuits, PLA (programmable logic array), PLD (programmable logic device), ROM (read only memory), and so forth.

Because of a relatively large attenuation along the signal path due to high frequencies of the high frequency transmission and reception signals, since the attenuation of the signals, which is amplified by PA to the power as high as approximately 1 W, may lead to the decrease of battery life time as well as the generation of heat in the equipment, the PAs and the high frequency control unit are often arranged more closely to each other in the layout of PAs and the switching unit. As clearly found from the comparison of FIGS. 1 and 2, the paths of control signals in the layout of FIG. 1 between the high frequency control unit 140 and PA1 through PA4 intersect the high frequency transmission and reception signal paths between the high frequency control unit 140 and the switching unit 100. By contrast, in the layout of FIG. 2A, since the control signal paths between the switching unit 100a and PA1 through PA4 are routed substantially parallel to the high frequency transmission and reception signal paths, and the intersection between the signal paths is eliminated, the restrictions on the layout is alleviated, and simpler layouts become feasible, as a result. In addition, four control signal lines from the high frequency control unit can be eliminated.

Incidentally, it may not be necessary to apply the present invention to all bands, and the combination may alternatively be considered with the system in which PA is controlled directly from the high frequency control unit as shown in FIG. 1, depending on the bands.

In addition, the above description has been made on the condition that ON/OFF of PA and also the ON/OFF of SW are each turned ON when the control signal becomes high (H). Since the ON/OFF may change depending on the system or equipment, it is not necessarily limited only to the case of controlling PAs according to the AND logic. This is also similar in the description of the following embodiments of the invention.

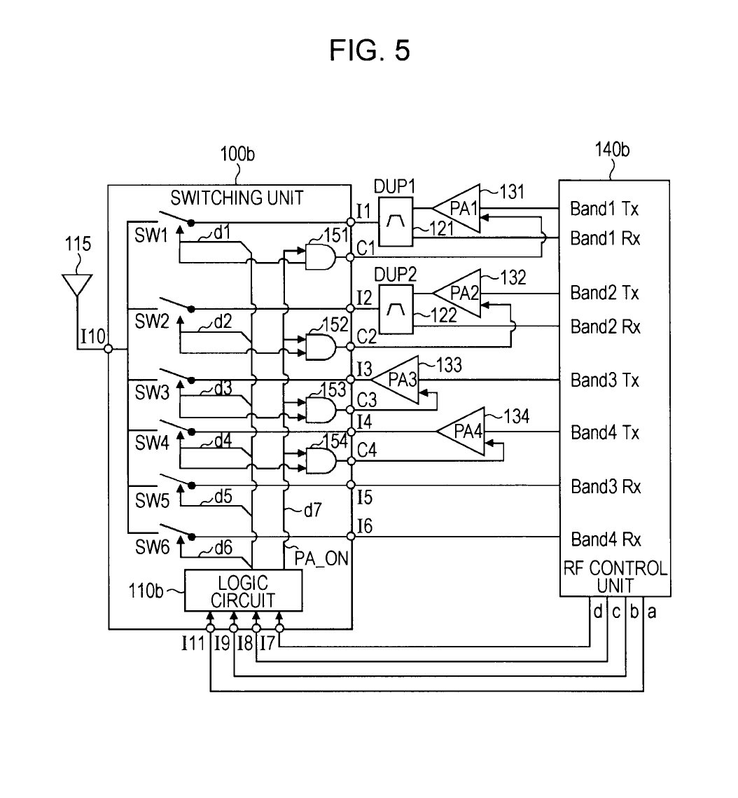

FIG. 5 illustrates the configuration of the portion of multi-band mobile-phone terminal related to the present invention according to a second embodiment. The components included in the drawing similar to those shown in FIG. 2 are indicated with identical numerical representations and the repeated description thereof is herewith excluded.

With the configuration shown in FIG. 2A, when the control of SW and PA are carried out by an arbitrary logic with the logic circuit 110a, the state of SW may become unstable since the logic will be brought into a transient state in the course of switching ON/OFF (ON/OFF of PA) of the transmission. Namely, by thus incurred instability of SW, there may result in the increase of power loss of received signals, the increase in signal distortion, the degradation in received signal quality, and in the worst case, the disconnection of ongoing connections. Therefore, it is devised in the second embodiment that logic gates (AND circuits 151 to 154 herein) are appended to PA1 to PA4, respectively, and that one more control signal d is generated in addition to the control signals, a to c, by the high frequency control unit 140b, as well. The logic circuit 110b is configured, as 4 input-7 output device, to generate control signals d1 to d7. In the present embodiment, control signals d1 to d4 are inputted each into one of the input terminals of the AND circuits 151 to 154, and a control signal d7 (PA_ON) is inputted in common into the other terminals of the AND circuits, as an independent power amplifier control signal which is specialized for use in ON/OFF operations of PAs. The logical product outputs from the AND circuits 151 to 154 are each used for controlling corresponding PA1 to PA4, respectively.

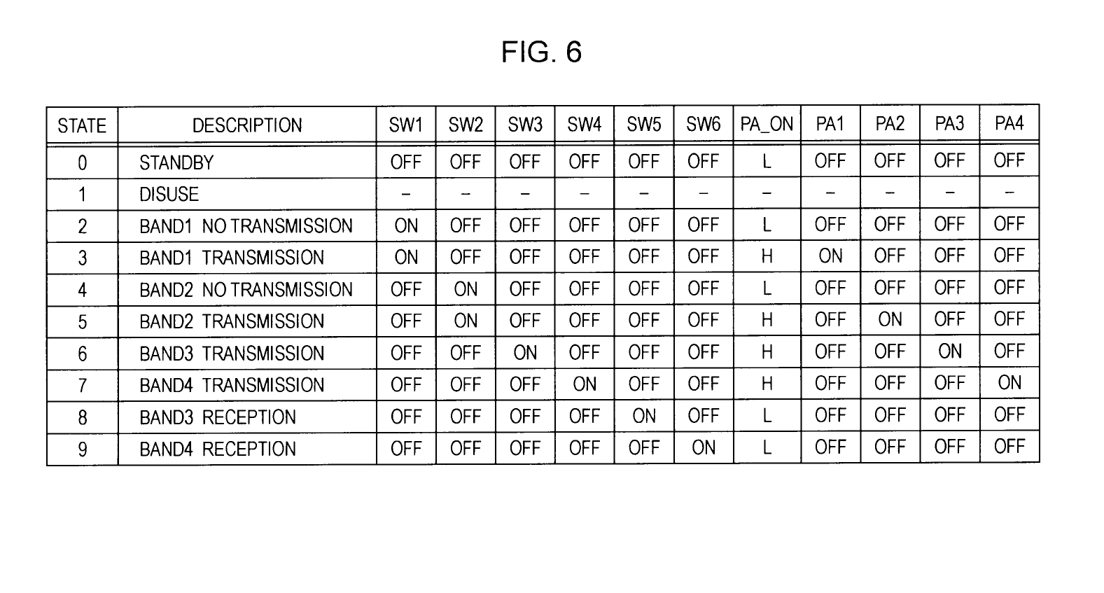

FIG. 6 is a diagram illustrating ON/OFF states of each of the switches (SW) and power amplifiers (PA), and of the control signal d7 (PA_ON) corresponding to several operation process with the configuration of FIG. 5. Regarding the relation between each band and state, the states 2 to 9 of FIG. 6 correspond to the states 0 to 7 of FIG. 3. The state 0 in FIG. 6 corresponds to the standby state, while the state 1 is of disuse.

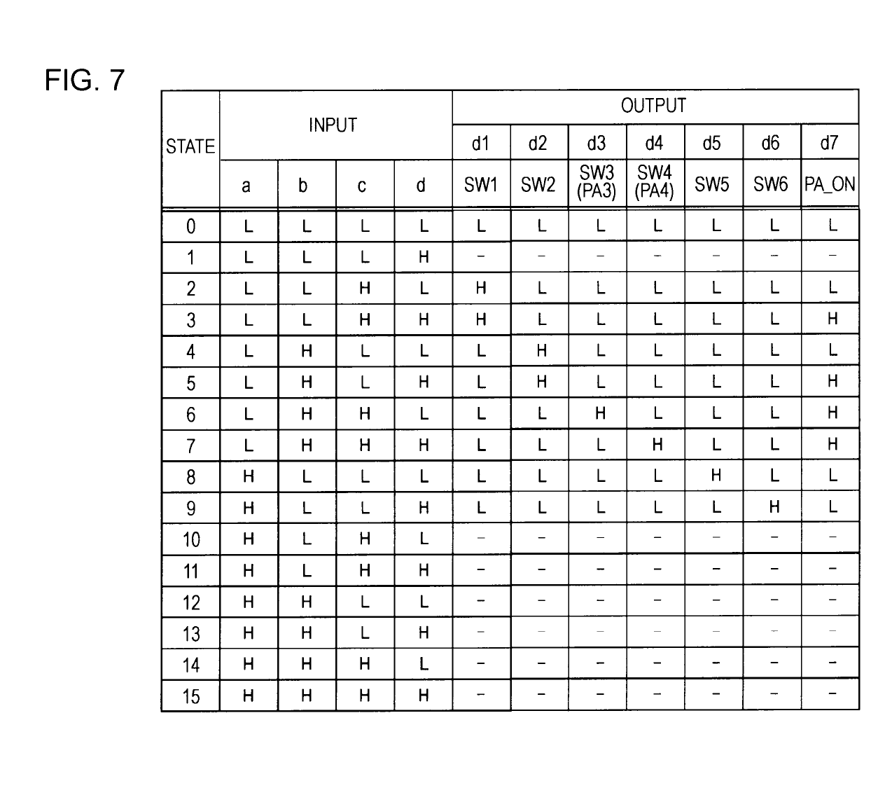

FIG. 7 includes a truth table for the 4 input-7 output logic circuit 110b included in the switching unit 100b of FIG. 5. As found in the table, control signal d7 (PA_ON) is added as the output of the logic circuit. This control signal d7 coincides with the input control signal d, and is used only for controlling AND circuits 151 to 154 irrespective of the state of each SW.

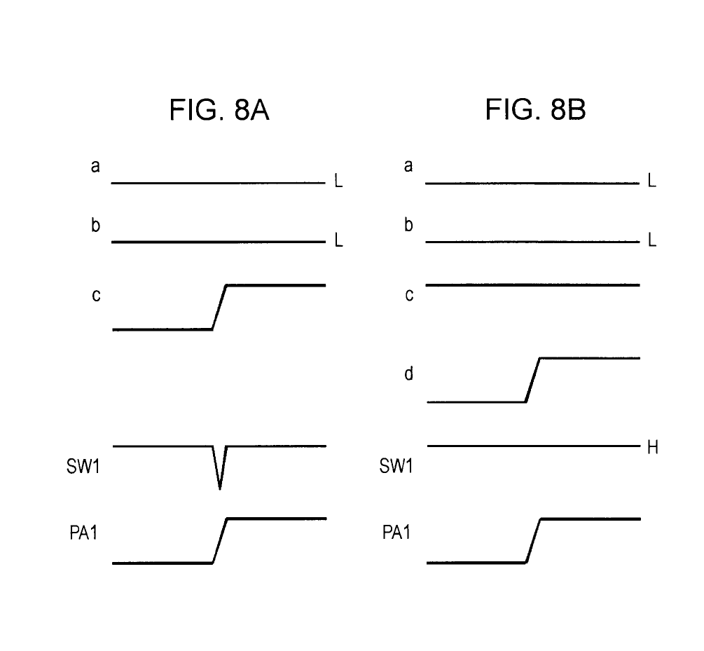

FIGS. 8A and 8B illustrate the action and effect with the configuration of the second embodiment. The drawings show the features of the state changes of SW1 and PA1 taking place during the switching from the state of band 1 where no transmission occurs to the state of band 1 where transmission occurs, and the examples of waveforms with time for the control signals relevant to the state changes. FIG. 8A illustrates the changes of control signal for the first embodiment, while FIG. 8B illustrates the changes for the second embodiment. In the case of the first embodiment, there is the possibility for the SW1 to be subjected to a transient operation such as shown in the drawing when PA1 changes its state from OFF to ON. According to the second embodiment, by contrast, the ON/OFF of SW can be prevented from such effect by the addition of AND circuit and by additionally applying control signal d in response to the H/L change of control signal PA_ON. In other word, during the change of the power amplifier state, input control signals, a through c, which are relevant to the change of switch state, are secured to remain unchanged. As a result, the occurrence of instability of the reception can be alleviated during the transient state from the period where no transmission occurs to the period where transmission occurs. Therefore, the aforementioned difficulty shown in FIG. 8A is solved. Namely, by separating the control signal for PA from the control signals for SW, the state of SW is stabilized irrespective of the presence or absence of the transmission.

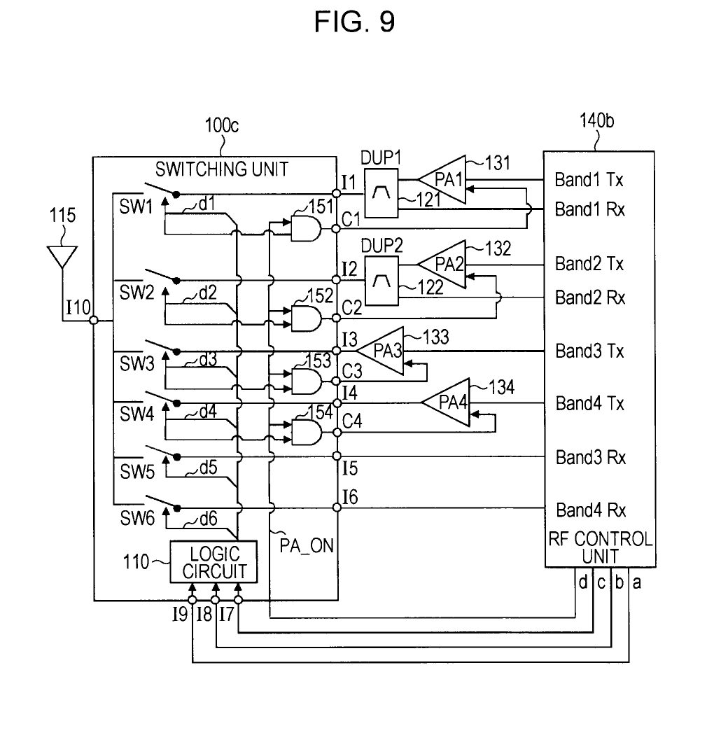

FIG. 9 illustrates the configuration of the portion of multi-band mobile-phone terminal related to the present invention according to a third embodiment. The components included in the drawing similar to those shown in FIG. 5 are indicated with identical numerical representations and the repeated description thereof is herewith excluded.

In the case of the second embodiment, the timing for leading the PA can be determined by the setup of software for the high frequency control unit. However, because of the variation in delay of the control signal from the logic circuit in the switching unit, the case may arise where the influence of the delay is not neglected.

In the present embodiment, therefore, the control signal d as-is from the high frequency control unit 140b is used as the control signal PA_ON of the switching unit 100c to be utilized for controlling AND circuits 151 to 154. Namely, the control signal d is assigned to the ON/OFF control of PA1 to PA4. As a result, the control of PA1 to PA4 with the switching unit 100c is directed only to the AND circuits, and the influence caused by the delay of the control signal can be minimized, thereby the abovementioned difficulty is solved.

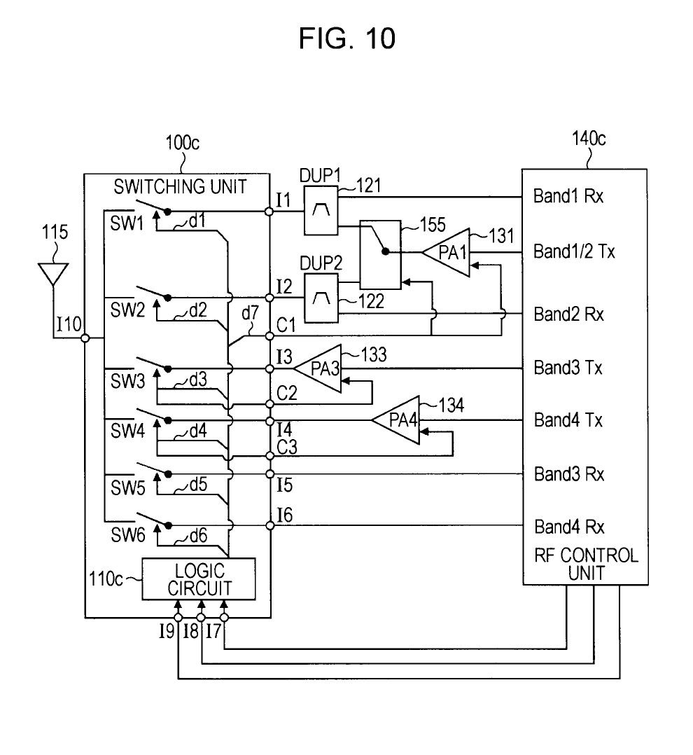

FIG. 10 illustrates the configuration of the portion of multi-band mobile-phone terminal related to the present invention according to a fourth embodiment. The components included in the drawing similar to those shown in the aforementioned drawings are indicated with identical numerical representations and the repeated description thereof is herewith excluded.

In the case where two or more bands of different communication systems are set to operate at frequencies close to each other, there may be used another configuration such as illustrated, in which an amplifier unit (PA1 in this example) is shared to be connected to the duplexers 121 and 122 of respective bands by means of a second switching unit 155. The present invention can be applied in this case as well. To this end, both a switch control signal d7 to the second switching unit 155 and ON/OFF control signal d8 to power amplifier PA1 are generated by the logic circuit 110c.

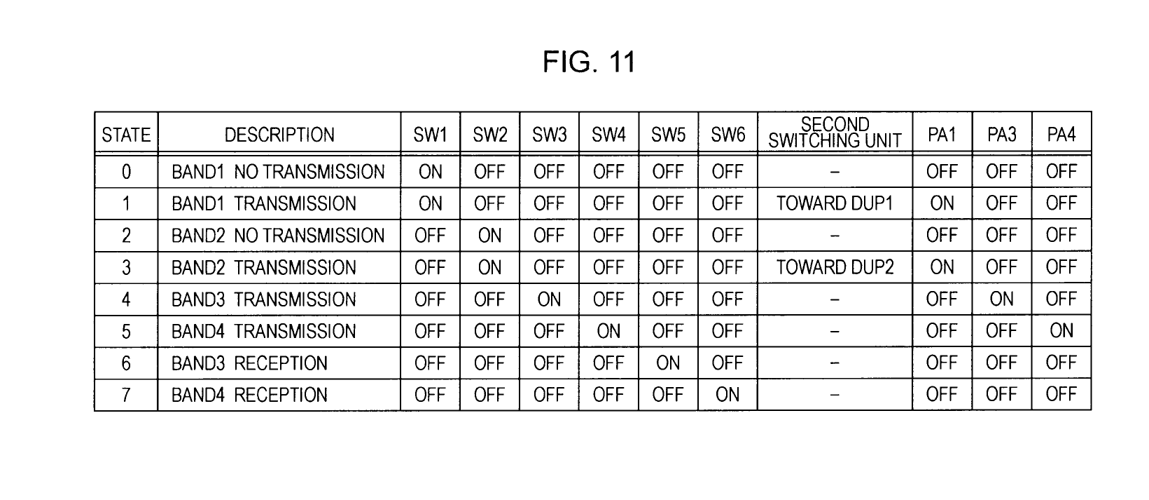

FIG. 11 is a diagram illustrating ON/OFF states of respective switches (SW), the second switching unit 155, respective power amplifiers (PA), and of the control signal PA_ON corresponding to several operation process with the configuration of FIG. 10. As shown in the drawing, the second switching unit 155 is controlled to switch to the side of DUP1 in the state 1, while to the side of DPU2 in the state 3.

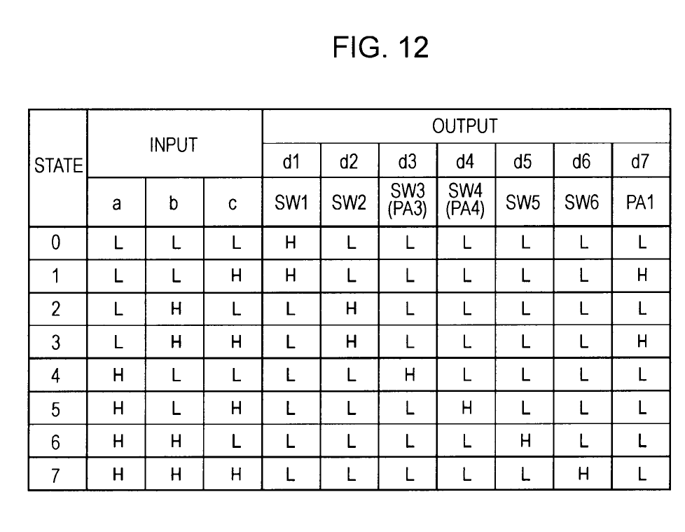

FIG. 12 includes a truth table for the 3 input-8 output logic circuit 110b included in the switching unit 100c of FIG. 10. According to input signals a through c of the logic circuit 110c, control signals d1 through d8 are generated. In this example, the switch control signal d7 to the switching unit 155 is shown so that the switching unit 155 is switched to the side of DUP1 for H, while to the side of DUP2 for L.

Also in the fourth embodiment, the configuration may be employed in which PA control signals are generated by AND circuits in a manner similar to the second embodiment.

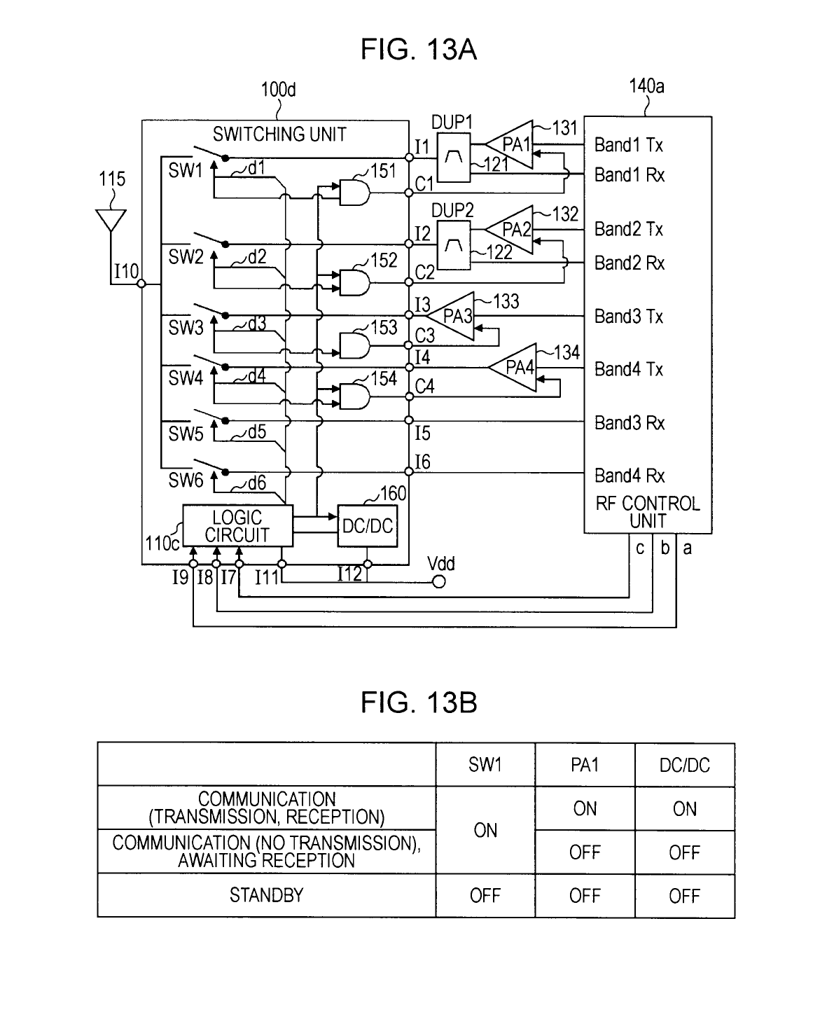

FIG. 13A illustrates the configuration of the portion of multi-band mobile-phone terminal related to the present invention according to a fifth embodiment. FIG. 3B shows a diagram illustrating the states related to the configuration. The components included in the drawing similar to those shown in the aforementioned drawings are indicated with identical numerical representations and the repeated description thereof is herewith excluded.

The switching unit 100d is provided therein with a step-up type DC/DC converter 160 (voltage conversion means). Although the source voltage has not been specifically described in the aforementioned embodiments, a power supply voltage Vdd is specified herein. A terminal I11 is an input terminal of the power supply voltage connected to the logic circuit, and a terminal I12 is an input terminal of the power supply voltage connected to the DC/DC converter 160. Since transmission signals of mobile-phone terminals turn to be high frequency signals with amplitude as large as approximately 18 V (33 dBm for GSM) at the maximum output, degradation in linearity of the signal may be caused by SW from the amplitude of the high frequency signals. At worst, an unintended SW is turned to ON state and whole the transmission and reception of the phone terminals come to be unstable. As a measure to alleviate this difficulty, the control voltage of SW is sufficiently increased by the step-up DC/DC converter 160. However, since reception signals are generally with amplitudes as large as several tenths of volt at most, the DC/DC converter 160 does not have to operate. In addition, there is another difficulty with the DC/DC converter 160 of relatively large current consumption.

Therefore, the step-up DC/DC converter 160 is subjected to ON/OFF operation corresponding to ON/OFF control of PA according to the second embodiment so that the control voltage of SW is increased only during the period of transmission with the DC/DC converter 160. In the case illustrated in the drawing, the DC/DC converter 160 becomes ON when the control signal d7 is H, the output voltage, which is obtained by raising the power voltage Vdd received from the terminal 12 to a predetermined voltage, is applied to the logic circuit 110c by way of an output line 161. At this time, in place of Vdd from the terminal I11, the logic circuit 110c utilizes the increased voltage, which is applied from the output line 161, as the control signals for SW1 to SW6. Since the DC/DC converter 160 is turned OFF during no transmission occurs, wasteful current consumption of the switching unit 100d can be alleviated.

In addition, in case where the ON/OFF control signal of PA does not coincide with ON/OFF of the DC/DC converter 160, a NOT circuit is inserted to the control input terminal of DC/DC converter 160 where necessary.

Such use of DC/DC converter 160 may similarly be adapted to other embodiments in which the AND circuit is not included.

In addition, also in the present embodiment, the control signals from the high frequency control unit can be used directly for controlling AND circuits in a manner similar to the third embodiment.

While the present invention has been described hereinabove with reference to the preferred embodiments and specific examples, numerous modifications and alteration of the examples are feasible besides those examples mentioned earlier.

The present application contains subject matter related to that disclosed in Japanese Priority Patent Application JP 2009-174418 filed in the Japan Patent Office on Jul. 27, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A mobile-phone terminal, comprising:
an antenna;
a switching unit configured to switch for selectively connecting a first plurality of signal paths of high frequency transmission and reception signals to the antenna, the first plurality of signal paths being compliant with a second plurality of communication systems;
a high frequency control unit configured to perform a switching control of the switching unit; and
a third plurality of power amplifiers configured to perform a power amplification of the high frequency transmission and reception signals compliant with the second plurality of communication systems, wherein
the switching unit includes
a fourth plurality of switching means for performing ON/OFF operations of each of the signal paths, and
a logic circuit configured, in response to control signals outputted from the high frequency control unit, to generate switching control signals for switching the fourth plurality of switching means and ON/OFF control signals for controlling the third plurality of power amplifiers.

2. The mobile-phone terminal according to claim 1, wherein
a part of the switching control signals for switching the fourth plurality of switching means is shared as ON/OFF control signals for controlling at least one of the third plurality of power amplifiers.

3. The mobile-phone terminal according to claim 1, wherein
the logic circuit is configured, in response to control signals outputted from the high frequency control unit, to generate independent power amplifier control signals for controlling the third plurality of power amplifiers; and
the switching unit further includes a fifth plurality of logic gates for generating ON/OFF control signals for controlling at least one of the third plurality of power amplifiers, the fifth plurality of logic gates being configured to generate logical product outputs as ON/OFF control signals for controlling the third plurality of power amplifiers, the logical product outputs being derived from the switching control signals for switching the fourth plurality of switching means and the power amplifier control signals outputted from the logic circuit.

4. The mobile-phone terminal according to claim 1, wherein
the switching unit further includes a fifth plurality of logic gates for generating ON/OFF control signals for controlling at least one of the third plurality of power amplifiers, the fifth plurality of logic gates being configured to generate logical product outputs as ON/OFF control signals for controlling the third plurality of power amplifiers, the logical product outputs being derived from the switching control signals for switching the fourth plurality of switching means and the power amplifier control signals outputted from the high frequency control unit.

5. The mobile-phone terminal according to claim 1, 2, 3, or 4, wherein
a high frequency transmission path and a high frequency reception path are connected to one single switch by way of a duplexer for a communication system carrying out a transmission and a reception simultaneously.

6. The mobile-phone terminal according to claim 1, 2, 3, 4, or 5, wherein
the switching unit further includes voltage conversion means for raising a control voltage of at least one of the fourth plurality of switching means, and the logic circuit is configured to increase a control voltage of the at least one of the fourth plurality of switching means with the voltage conversion means only during a period of transmission of at least one of the second plurality of communication systems.

7. A high-frequency multiplexing system, comprising:
a switching unit configured to switch for selectively connecting a first plurality of signal paths of high frequency transmission and reception signals, the first plurality of signal paths being compliant with a second plurality of communication systems; and
a high frequency control unit configured to perform a switching control of the switching unit, wherein
the switching unit includes
a fourth plurality of switching means for performing ON/OFF operations of each of the signal paths, and
a logic circuit configured, in response to control signals outputted from the high frequency control unit, to generate switching control signals for switching the fourth plurality of switching means and ON/OFF control signals for controlling the third plurality of power amplifiers for performing a power amplification of high-frequency transmission signals.

8. The high-frequency multiplexing system according to claim 7, wherein
a part of the switching control signals for switching the fourth plurality of switching means is shared as ON/OFF control signals for controlling at least one of the third plurality of power amplifiers.

9. The high-frequency multiplexing system according to claim 7, wherein
the logic circuit is configured, in response to control signals outputted from the high frequency control unit, to generate independent power amplifier control signals for controlling the third plurality of power amplifiers; and
the switching unit further includes a fifth plurality of logic gates for generating ON/OFF control signals for controlling at least one of the third plurality of power amplifiers, the fifth plurality of logic gates being configured to generate logical product outputs as the ON/OFF control signals, the logical product outputs being derived from the switching control signals for switching the fourth plurality of switching means and the power amplifier control signals outputted from the logic circuit.

10. The high-frequency multiplexing system according to claim 7, wherein
the switching unit further includes a fifth plurality of logic gates for generating ON/OFF control signals for controlling at least one of the third plurality of power amplifiers, the fifth plurality of logic gates being configured to generate logical product outputs as ON/OFF control signals for controlling the third plurality of power amplifiers, the logical product outputs being derived from the switching control signals for switching the fourth plurality of switching means and the power amplifier control signals outputted from the high frequency control unit.

11. The high-frequency multiplexing system according to claim 7, 8, 9, or 10, further comprising:
a voltage conversion means for raising a control voltage of at least one of the fourth plurality of switching means, wherein
the logic circuit is configured to increase a control voltage of the at least one of the fourth plurality of switching means with the voltage conversion means only during a period of transmission of at least one of the second plurality of communication systems.

12. A high-frequency switching system, comprising:
a switching unit configured to switch for selectively connecting a first plurality of signal paths of high frequency transmission and reception signals, the first plurality of signal paths being compliant with a second plurality of communication systems; wherein
the switching unit includes
a fourth plurality of switching means for performing ON/OFF operations of each of the signal paths;
a sixth plurality of control input terminals for receiving a seventh plurality of control signals from an exterior;
a logic circuit configured, in response to the seventh plurality of control signals, to generate switching control signals for switching the fourth plurality of switching means and ON/OFF control signals for controlling the third plurality of power amplifiers for performing a power amplification of high-frequency transmission signals; and
an eighth plurality of output terminals for outputting the ON/OFF control signals for controlling the third plurality of power amplifiers.

13. The high-frequency switching system according to claim 12, wherein
a part of the switching control signals for switching the fourth plurality of switching means is shared as ON/OFF control signals for controlling at least one of the third plurality of power amplifiers.

14. The high-frequency switching system according to claim 12, further comprising:
a fifth plurality of logic gates for generating ON/OFF control signals for controlling at least one of the third plurality of power amplifiers;
wherein
the logic circuit is configured, in response to the seventh plurality of control signals from an exterior, to generate independent power amplifier control signals for controlling the third plurality of power amplifiers; and
the fifth plurality of logic gates are configured to generate logical product outputs as the ON/OFF control signals, the logical product outputs being derived from the switching control signals for switching the fourth plurality of switching means and the power amplifier control signals outputted from the logic circuit.

15. The high-frequency switching system according to claim 12, further comprising:
a fifth plurality of logic gates for generating ON/OFF control signals for controlling at least one of the third plurality of power amplifiers; and
a control input terminal for receiving a power amplifier control signal from an exterior;
wherein
the fifth plurality of logic gates are configured to generate logical product outputs as ON/OFF control signals for controlling the third plurality of power amplifiers, logical product outputs being derived from the switching control signals for switching the fourth plurality of switching means and the power amplifier control signals received from the exterior.

16. The high-frequency switching system according to claim 12, 13, 14, or 15, further comprising:
a voltage conversion means for raising a control voltage of at least one of the fourth plurality of switching means; wherein
the logic circuit is configured to increase a control voltage of the at least one of the fourth plurality of switching means with the voltage conversion means only during a period of transmission of at least one of the second plurality of communication systems.

17. A mobile-phone terminal, comprising:
an antenna;
a switching unit configured to switch for selectively connecting a first plurality of signal paths of high frequency transmission and reception signals to the antenna, the first plurality of signal paths being compliant with a second plurality of communication systems;
a high frequency control unit configured to perform a switching control of the switching unit; and
a third plurality of power amplifiers configured to perform a power amplification of the high frequency transmission and reception signals corresponding to the second plurality of communication systems, wherein
the switching unit includes
a fourth plurality of switching devices configured to perform ON/OFF operations of each of the signal paths, and
a logic circuit configured, in response to control signals outputted from the high frequency control unit, to generate switching control signals for switching the fourth plurality of switching devices and ON/OFF control signals for controlling the third plurality of power amplifiers.

18. A high-frequency multiplexing system, comprising:
a switching unit configured to switch for selectively connecting a first plurality of signal paths of high frequency transmission and reception signals, the first plurality of signal paths being compliant with a second plurality of communication systems; and
a high frequency control unit configured to perform a switching control of the switching unit; wherein
the switching unit includes
a fourth plurality of switching devices configured to perform ON/OFF operations of each of the signal paths, and
a logic circuit configured, in response to control signals outputted from the high frequency control unit, to generate switching control signals for switching the fourth plurality of switching devices and ON/OFF control signals for controlling the third plurality of power amplifiers for performing a power amplification of high-frequency transmission signals.

19. A high-frequency switching system, comprising:
a switching unit configured to switch for selectively connecting a first plurality of signal paths of high frequency transmission and reception signals, the first plurality of signal paths being in accordance to a second plurality of communication systems; wherein
the switching unit includes
a fourth plurality of switching devices configured to perform ON/OFF operations of each of the signal paths;
a sixth plurality of control input terminals for receiving a seventh plurality of control signals from an exterior;
a logic circuit configured, in response to the seventh plurality of control signals, to generate switching control signals for switching the fourth plurality of switching devices and ON/OFF control signals for controlling the third plurality of power amplifiers for performing a power amplification of high-frequency transmission signals; and
an eighth plurality of output terminals for outputting the ON/OFF control signals for controlling the third plurality of power amplifiers.
